(19) United States
(12) Patent Application Publication
(10) Pub. No.: US 2017/0192393 A1
(43) Pub. Date: Jul. 6, 2017

(54) POINTER DRIVING MOTOR UNIT AND CONTROL METHOD OF POINTER DRIVING MOTOR UNIT

(71) Applicant: Seiko Instruments Inc., Chiba-shi (JP)

(72) Inventors: Kenji OGASAWARA, Chiba-shi (JP); Masayuki KAWATA, Chiba-shi (JP); Kazuhiro KOYAMA, Chiba-shi (JP)

(21) Appl. No.: 15/394,017

(22) Filed: Dec. 29, 2016

(30) Foreign Application Priority Data
Jan. 5, 2016 (JP) 2016-000685

(51) Int. Cl. G04C 3/14; G04B 19/04

(52) U.S. Cl. CPC G04C 3/14; G04B 19/04

(57) ABSTRACT

A pointer driving motor unit includes: a support body; a pointer which is rotatably supported by the support body; a stepping motor which rotates the pointer; an input portion into which an input signal is put from a main control portion connected to the support body from the outside of the support body; and a control portion which is disposed in the support body, and controls driving of the stepping motor in accordance with the input signal.

### RELATED APPLICATIONS

This application claims priority under 35 U.S.C. §119 to Japanese Patent Application No. 2016-000685 filed on Jan. 5, 2016, the entire content of which is hereby incorporated by reference.

### BACKGROUND OF THE INVENTION

1. Field of the Invention

The present invention relates to a pointer driving motor unit and a control method of the pointer driving motor unit.

2. Description of the Related Art

In JP-A-2002-323577, an electronic clock configured of a time display module and an additional module is disclosed. On the time display module described in JP-A-2002-323577, a crystal vibrator, a MOSIC chip, a wheel train, a motor, and a battery are loaded, and on the additional module, a driving IC for an additional function is loaded. The time display module is configured to have the battery which is a power source that drives a main control portion (microcomputer) loaded thereon, also have a quartz which is a reference clock of a system including the main control portion loaded thereon, and the entire time display module is configured to be completed as a clock. In other words, the time display module is a module in which movement of an analogue clock in the related art is unitized.

### SUMMARY OF THE INVENTION

However, in the technology described in JP-A-2002-323577, it was often difficult for the time display module to reduce the size thereof. Here, in a case where it is also desired to control the additional module other than the time display module, the main control portion of the time display module should take a burden thereon, and this becomes a restriction of the reduction of the size. In addition, in the main control portion in the unitized module, when the number of additional modules increases or the functions of each module are improved, a case where it is not possible to respond thereto due to a processing load or the restriction of the size in the main control portion may occur.

Considering the above-described circumstances, an object of the invention is to provide a pointer driving motor unit which satisfies the reduction of the size of the unit and ensuring of controllability in a case where a plurality of the units are incorporated, at the same time, and a control method of the pointer driving motor unit.

In order to achieve the above-described object, according to an aspect of the invention, there is provided a pointer driving motor unit including: a support body; a pointer which is rotatably supported by the support body; a stepping motor which rotates the pointer; an input portion into which an input signal is put from a main control portion connected to the support body from the outside of the support body; and a control portion which is disposed in the support body, and controls driving of the stepping motor in accordance with the input signal.

In the pointer driving motor unit according to the aspect of the invention, the support body may include an output portion which outputs an output signal that controls other units connected to the outside of the support body, and the control portion may generate the output signal which controls the other units in accordance with information included in the input signal.

In the pointer driving motor unit according to the aspect of the invention, an oscillation circuit which is disposed in the support body, and outputs a reference signal, may further be provided, and the control portion may control the driving of at least one of the stepping motor and a stepping motor that drives the pointer supported by the other units, in synchronization with the reference signal output by the oscillation circuit, based on the information included in the input signal.

In the pointer driving motor unit according to the aspect of the invention, the control portion may control the driving of the stepping motor based on the reference signal in a case where the input signal is not input to the input portion for a predetermined time period or longer.

In the pointer driving motor unit according to the aspect of the invention, the control portion may output a signal which indicates that the control is performed to the main control portion via the input portion while controlling the driving of at least one of the stepping motor and the stepping motor that drives the pointer supported by the other units, in accordance with the information included in the input signal.

In the pointer driving motor unit according to the aspect of the invention, the stepping motor may include a first stepping motor and a second stepping motor, and the pointer may include a minute hand which is driven by the first stepping motor, and an hour hand which is driven by the second stepping motor.

In the pointer driving motor unit according to the aspect of the invention, a plurality of the other units may be provided, a plurality of the output portions may be provided to be capable of outputting the output signal to each of the other units, and the control portion may generate the plurality of output signals which control each of the other units, and output the output signals to the plurality of outputs portions.

In the pointer driving motor unit according to the aspect of the invention, the other units may include at least one of a sound generation element, a light emitting element, and a vibration element.

In order to achieve the above-described object, according to another aspect of the invention, there is provided a control method of a pointer driving motor unit including a support body, a pointer which is rotatably supported by the support body, a stepping motor which rotates the pointer, an input portion into which an input signal is put from a main control portion connected to the support body from the outside of the support body, an output portion which outputs a signal that controls driving of other units connected to the support body from the outside of the support body, and a control portion which is disposed in the support body, the method including: a procedure of controlling driving of at least one of the stepping motor and a stepping motor that drives the pointer supported by the other units, in accordance with the signal input from the main control portion.

According to the invention, it is possible to satisfy the reduction of the size of the unit and ensuring of controllability in a case where a plurality of the units are incorporated, at the same time.

### BRIEF DESCRIPTION OF THE DRAWINGS

FIG. 1 is a configuration view illustrating a configuration of a multifunctional electronic device according to the embodiment.

FIG. 2 is a view illustrating an example of information stored in a storage portion according to the embodiment.

FIG. 3 is a configuration view illustrating a configuration of a multifunctional electronic device according to the technology in the related art.

FIG. 4 is a view illustrating an example in which a main control portion, a first pointer driving motor unit, a second pointer driving motor unit, a third pointer driving motor unit, and a fourth pointer driving motor unit are disposed on a base body according to the embodiment.

FIG. 5 is a view illustrating connection between the main control portion and the first pointer driving motor unit, and connection between the first pointer driving motor unit and the second pointer driving motor unit, according to the embodiment.

FIG. 6 is a view illustrating an example of a communication signal between the main control portion and a control portion, and an example of a driving signal which is output to each motor by the control portion, according to the embodiment.

FIG. 7 is a sequence view of processing of the multifunctional electronic device according to the embodiment.

### DETAILED DESCRIPTION OF THE PREFERRED EMBODIMENTS

Hereinafter, an embodiment of the invention will be described with reference to the drawings.

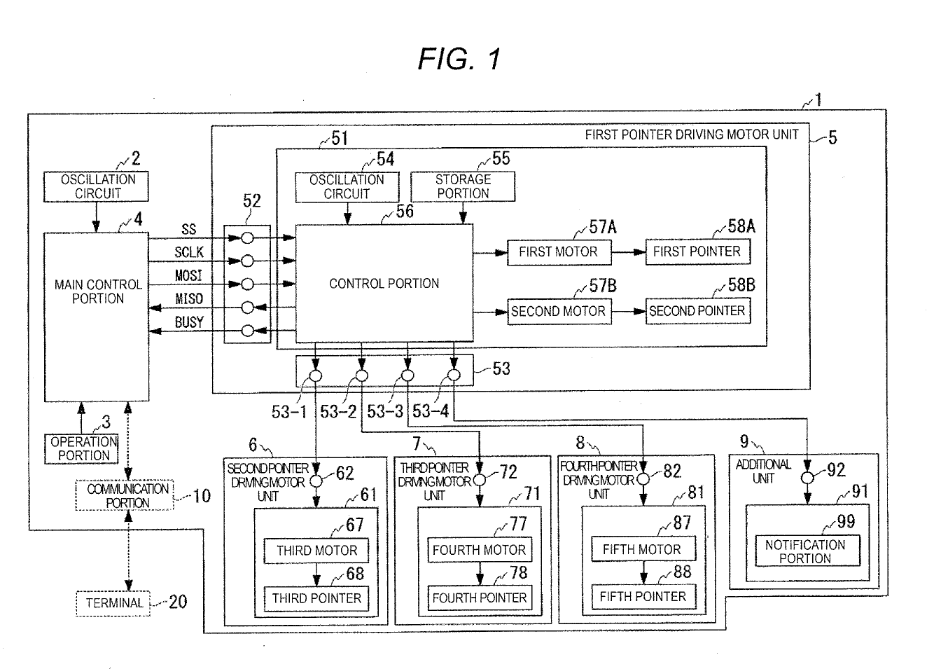

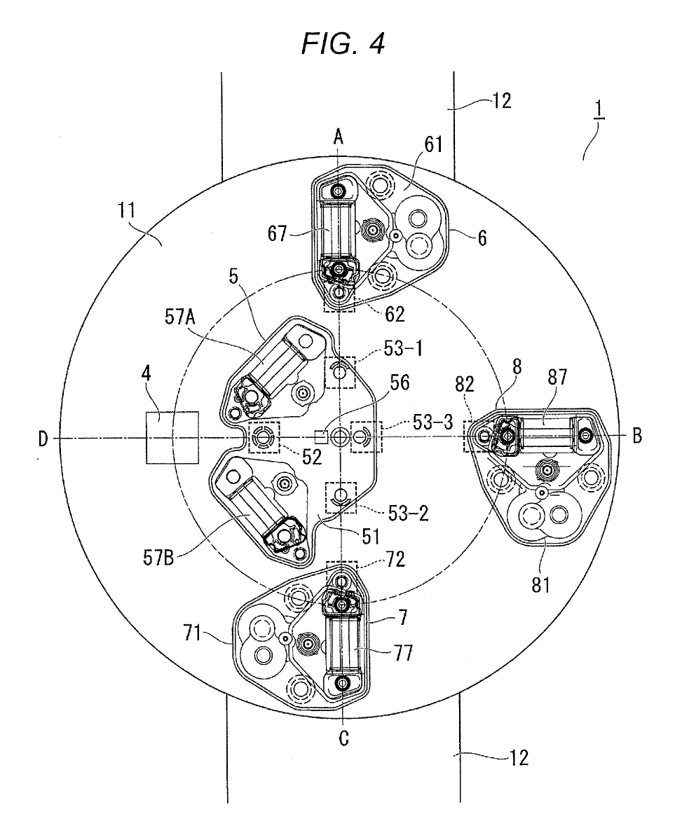

FIG. 1 is a configuration view illustrating a configuration of a multifunctional electronic device 1 according to the embodiment. In addition, the multifunctional electronic device 1 is, for example, a smart watch. As illustrated in FIG. 1, the multifunctional electronic device 1 is provided with an oscillation circuit 2, an operation portion 3, a main control portion 4, a first pointer driving motor unit 5, a second pointer driving motor unit 6, a third pointer driving motor unit 7, a fourth pointer driving motor unit 8, an additional unit 9, and a communication portion 10. In addition, the multifunctional electronic device 1 is provided with a belt 12 (FIG. 4) which is used for mounting the device on an arm or the like of a user or another fixed location. In addition, the multifunctional electronic device 1 may communicate with a terminal 20, and may send and receive information. The terminal 20 is a portable terminal, such as smart phone, a tablet terminal, a personal computer, and portable game equipment.

In addition, in the example illustrated in FIG. 1, an example in which the multifunctional electronic device 1 is provided with a plurality of units, is illustrated, but the multifunctional electronic device 1 may be provided with at least the first pointer driving motor unit 5 among the plurality of units.

The oscillation circuit 2, the operation portion 3, and the communication portion 10 are connected to the main control portion 4, and further, the first pointer driving motor unit 5 is connected thereto by five (SS, SCLK, MOSI, MISO, BUSY) signal lines.

The first pointer driving motor unit 5 is provided with a support body 51, an input portion 52, an output portion 53, an oscillation circuit 54, a storage portion 55, a control portion 56, a first motor 57A, a second motor 57B, a first pointer 58A, and a second pointer 58B. The second pointer driving motor unit 6 is provided with a support body 61, an input portion 62, a third motor 67, and a third pointer 68. The third pointer driving motor unit 7 is provided with a support body 71, an input portion 72, a fourth motor 77, and a fourth pointer 78. The fourth pointer driving motor unit 8 is provided with a support body 81, an input portion 82, a fifth motor 87, and a fifth pointer 88. The additional unit 9 is provided with a support body 91, an input portion 92, and a notification portion 99. In addition, in a case where one of the first pointer driving motor unit 5, the second pointer driving motor unit 6, the third pointer driving motor unit 7, the fourth pointer driving motor unit 8, and the additional unit 9 is not specified, the units are simply called a unit.

In addition, each of the second pointer driving motor unit 6, the third pointer driving motor unit 7, the fourth pointer driving motor unit 8, and the additional unit 9 is connected to the first pointer driving motor unit 5.

In the following description, an example in which each unit (the first pointer driving motor unit 5, the second pointer driving motor unit 6, the third pointer driving motor unit 7, the fourth pointer driving motor unit 8, and the additional unit 9) is operated as follows, will be described. In addition, the operation example is an example, and an operation of each unit is not limited thereto.

The first pointer driving motor unit 5 and the second pointer driving motor unit 6 displays hours, the first pointer driving motor unit 5 displays minutes and hours, and the second pointer driving motor unit 6 displays seconds. The third pointer driving motor unit 7 and the fourth pointer driving motor unit 8 display clocking passage or a clocking result by a chronograph function. The additional unit 9 notifies alarm sound at the time set by the user.

Next, each functional portion will be described.

The oscillation circuit 2 is provided with a crystal resonator, for example, having 32.768 kHz, and the crystal resonator generates a reference signal by dividing the generated signal, and outputs the generated reference signal to the main control portion 4. In addition, the reference signal is similar to a clock signal.

The operation portion 3 is, for example, a stem or a button. The operation portion 3 outputs the operation result operated by the user to the main control portion 4. In the operation result, for example, a time setting command, a chronograph measuring start command, a chronograph measuring finish command, a command for resetting the chronograph display, and alarm set time, are included.

The communication portion 10 sends and receives the information to and from the terminal 20, for example, by using a communication method of a standard of Bluetooth (registered trademark) Low Energy (LE) (hereinafter, referred to as BLE). In addition, the received information is information indicating the current time, information indicating that a mail is received, or information indicating notification of a reminder. The communication portion 10 outputs the received information to the main control portion 4. The communication portion 10 sends the information output by the main control portion 4 to an external device. The information output by the main control portion 4 is, for example, a response to the information received from the external device, information indicating the number of units provided in the multifunctional electronic device 1, or information indicating the number of pointers provided in the multifunctional electronic device 1. In addition, the multifunctional electronic device 1 may not be provided with the communication portion 10.

The main control portion 4 is, for example, a central processing unit (CPU), generates a command of operating the first pointer driving motor unit 5, the second pointer driving motor unit 6, and the third pointer driving motor unit 7 and displaying the time by using the reference signal output by the oscillation circuit 2, and outputs the generated command to the first pointer driving motor unit 5. The command is, for example, information of 8 bit. In addition, in accordance with the operation command output by the operation portion 3, the main control portion 4 selects a unit to be used among the first pointer driving motor unit 5, the second pointer driving motor unit 6, the third pointer driving motor unit 7, the fourth pointer driving motor unit 8, and the additional unit 9, generates a command which is a control command with respect to the selected unit, and outputs the generated command to the first pointer driving motor unit 5. In addition, in the command, information indicating the unit which is a control target is included, and in a case where there are a plurality of control targets in the unit, information indicating the control target is included. In addition, the command will be described later. In addition, the CPU is described as a concept including a microprocessor unit (MPU) and a microcontroller unit (MCU), and may be a unit which can achieve any of the function, an action, and an effect of the invention.

Next, the first pointer driving motor unit 5 will be described.

The first pointer driving motor unit 5 is, for example, a unit in which the first pointer 58A that is a short needle and the second pointer 58B that is a long needle are coaxially disposed, and which can display the time displaying hours and minutes. The first pointer driving motor unit 5 generates a driving signal which drives motors (57A, 57B, 67, 87) provided in each unit or the notification portion 99 by using the information stored by the storage portion 55 in accordance with the command of the main control portion 4. In a case where the information which is included in the command and indicates the unit which is a control target is the unit itself, the first pointer driving motor unit 5 operates the first pointer 58A and the second pointer 58B of the first pointer driving motor unit 5 by the generated driving signal. The first pointer driving motor unit 5 outputs the generated command to the unit (the second pointer driving motor unit 6, the third pointer driving motor unit 7, the fourth pointer driving motor unit 8, and the additional unit 9) which is a control target included in the command.

In addition, in a case where the main control portion 4 does not output the command for a predetermined time period or longer, the first pointer driving motor unit 5 operates the first pointer 58A and the second pointer 58B by performing the clocking using the SCLK output by the main control portion 4 or the reference signal generated by the oscillation circuit 54, further generates the driving signal for driving the third pointer 68, and outputs the generated driving signal to the second pointer driving motor unit 6.

The support body 51 includes a substrate, a bottom board which becomes a base, a backing board which holds the component disposed on the bottom board from an opposite side, and other case portions. The substrate is disposed on the bottom board, and a wheel train or the like which is a gear train that transmits torque from a wiring, the input portion 52, the output portion 53, the oscillation circuit 54, the storage portion 55, the control portion 56, the first motor 57A, the second motor 57B, and the motor, is disposed on the substrate. The units are assembled by fixing the components by the backing board. In addition, an electrode which becomes a connection terminal which will be described later is disposed on the bottom board, and the electrode plays a role of electrically conducting the electronic component on the inside and the outside of the unit.

In addition, the input portion 52 is a connection terminal, for example, connected with the main control portion 4.

The output portion 53 is a connection terminal, for example, connected with the second pointer driving motor unit 6, the third pointer driving motor unit 7, the fourth pointer driving motor unit 8, and the additional unit 9. The output portion 53 is provided with a first output portion 53-1, a second output portion 53-2, a third output portion 53-3, and a fourth output portion 53-4. The second pointer driving motor unit 6 is connected to the first output portion 53-1, the third pointer driving motor unit 7 is connected to the second output portion 53-2, the fourth pointer driving motor unit 8 is connected to the third output portion 53-3, and the additional unit 9 is connected to the fourth output portion 53-4. In addition, the unit connected to each connection terminal is determined in advance, or is set by a manufacturer when manufacturing or assembling the multifunctional electronic device 1.

The oscillation circuit 54 generates the reference signal used by the control portion 56, and outputs the generated reference signal to the control portion 56.

The storage portion 55 stores information including the type of the unit connected to the first pointer driving motor unit 5, and the number of the units. Here, the type of the unit is a unit provided with one motor and one pointer, a unit provided with two motors and two pointers, and a unit provided with the notification portion. In addition, the information related to the unit may be written in the storage portion 55 by the manufacturer during the assembly of the multifunctional electronic device 1 or after the assembly. Otherwise, the information related to the unit is sent, for example, to the communication portion 10 from a personal computer which is the terminal 20, and the main control portion 4 outputs the information related to the unit received by the communication portion 10 to the control portion 56. In addition, the control portion 56 may write the information related to the unit output by the main control portion 4 into the storage portion 55. In addition, the storage portion 55 stores the driving signal of the motors (57A, 57B, 67, 87) which correspond to the command output by the main control portion 4 or the notification portion 99.

The control portion 56 generates the driving signal (also referred to as a driving pulse) which drives the motor that corresponds to the corresponding unit or the notification portion by using the information stored by the storage portion 55 in accordance with the command output by the main control portion 4. In a case where the command is with respect to the unit itself, the control portion 56 outputs the generated driving signal to the first motor 57A and the second motor 57B. In a case where the command is with respect to other units, the control portion 56 outputs the generated driving signal to the corresponding unit (the second pointer driving motor unit 6, the third pointer driving motor unit 7, the fourth pointer driving motor unit 8, and the additional unit 9).

In addition, in a case where the main control portion 4 does not output the command for a predetermined time period or longer, the control portion 56 performs the clocking by using the SCLK output by the main control portion 4 or the reference signal generated by the oscillation circuit 54, generates each driving signal to the first motor 57A and the second motor 57B for operating the first pointer 58A and the second pointer 58B, and outputs the generated driving signal to the first motor 57A and the second motor 57B which corresponds to the generated driving signal. In addition, the control portion 56 generates the driving signal to the third motor 67 for driving the third pointer 68, and outputs the generated driving signal to the second pointer driving motor unit 6. A case where the control portion 56 detects a case where the main control portion 4 does not output the command for a predetermined time period or longer is a case where the signal from the main control portion 4 to the input portion 52 is not present even when the control portion 56 performs the clocking for a predetermined time period by the SCLK or the reference signal.

The first motor 57A and the second motor 57B are stepping motors. The first motor 57A drives the first pointer 58A, for example, via a gear (not illustrated), in accordance with the driving signal output by the control portion 56. The second motor 57B drives the second pointer 58B, for example, via a gear (not illustrated), in accordance with the driving signal output by the control portion 56.

The first pointer 58A is, for example, a short needle, and the short needle is, for example, an hour hand, and is rotatably supported by the support body 51. The second pointer 58B is, for example, a long needle, and the long needle is for example, a minute hand, and is rotatably supported by the support body 51.

Next, the second pointer driving motor unit 6 to the fourth pointer driving motor unit 8 will be described.

The second pointer driving motor unit 6 is, for example, a unit for displaying seconds. The second pointer driving motor unit 6 drives the third pointer 68 in accordance with the driving signal output by the first pointer driving motor unit 5. The third pointer driving motor unit 7 and the fourth pointer driving motor unit 8 are, for example, a unit which displays the clocking passage or the clocking result of the chronograph. The third pointer driving motor unit 7 drives the fourth pointer 78 in accordance with the driving signal output by the first pointer driving motor unit 5, and the fourth pointer driving motor unit 8 drives the fifth pointer 88 in accordance with the driving signal output by the first pointer driving motor unit 5.

Each of the support body 61, the support body 71, and the support body 81 includes the substrate, the bottom board which becomes a base, the backing board which holds the component disposed on the bottom board from an opposite side, and other case portions. The substrate is disposed on the bottom board, and the wheel train or the like which is the gear train that transmits the torque from the wiring, the connection portion (one of 62, 72, and 82), the motor (one of 67, 77, and 87 which corresponds to the connection portion), and the motor, is disposed on the substrate. The units are assembled by fixing the components by the backing board.

The third motor 67, the fourth motor 77, and the fifth motor 87 are stepping motors. The third motor 67 drives the third pointer 68, for example, via a gear (not illustrated), in accordance with the driving signal output by the first pointer driving motor unit 5. The fourth motor 77 drives the fourth pointer 78, for example, via a gear (not illustrated), in accordance with the driving signal output by the first pointer driving motor unit 5. The fifth motor 87 drives the fifth pointer 88, for example, via a gear (not illustrated), in accordance with the driving signal output by the first pointer driving motor unit 5.

The third pointer 68 is, for example, a second hand, and is rotatably supported by the support body 61. The fourth pointer 78 is a pointer, and is rotatably supported by the support body 71. The fifth pointer 88 is a pointer, and is rotatably supported by the support body 81. In addition, regarding the fourth pointer 78 and the fifth pointer 88, for example, when performing the chronograph clocking, the fourth pointer 78 displays the clocking passage per minute, and the fifth pointer 88 displays the clocking passage per second.

Next, the additional unit 9 will be described.

The additional unit 9 is a unit which performs the notification. The additional unit 9 drives the notification portion 99 in accordance with the driving signal output by the first pointer driving motor unit 5.

The support body 91 includes the substrate, the bottom board which becomes a base, the backing board which holds the component disposed on the bottom board from the opposite side, and other case portions. The substrate is disposed on the bottom board, and for example, the wiring, the input portion 92, and the notification portion 99 are disposed on the substrate.

The notification portion 99 is, for example, a buzzer (sound generation element), and notifies the sound in accordance with the driving signal output by the first pointer driving motor unit 5. In addition, the notification portion 99 may be a lamp (light emitting element) and a vibration element.

Next, an example of the information stored by the storage portion 55, will be described.

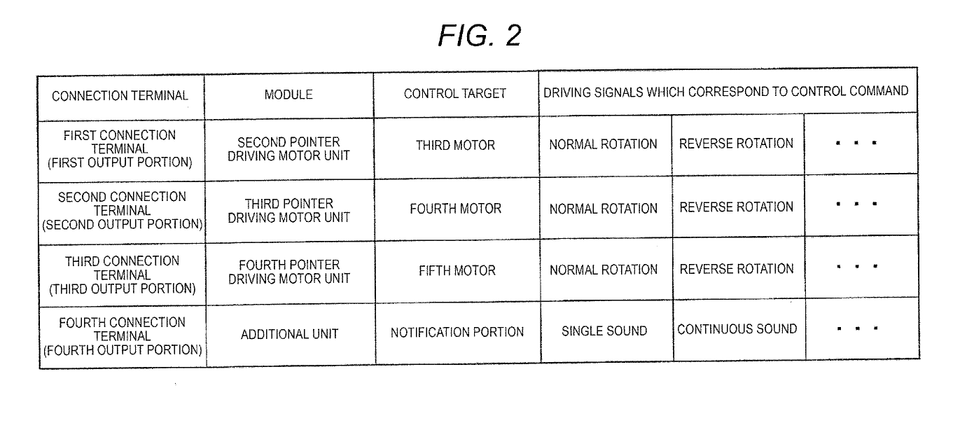

FIG. 2 is a view illustrating an example of the information stored by the storage portion 55 according to the embodiment. As illustrated in FIG. 2, the storage portion 55 stores the driving signal which corresponds to the connected unit, the control target, and the control command, in accordance with the connection terminal. The storage portion 55 stores the second pointer driving motor unit 6 as the connected unit, the third motor 67 as the control target, and normal rotation and reverse rotation as the driving signal that corresponds to the command, in accordance with the first output portion 53-1 which is the first connection terminal.

In addition, in the command of outputting the main control portion 4, the unit which is the control target, the motor or the notification portion which is the control target, and the control command are included. In addition, in the control command, in a case where the control target is the motor, the operation direction (normal rotation, reverse rotation) and the number of operating needles (the number of steps of normal rotation or the number of steps of reverse rotation), are included. In addition, the number of steps is the number of steps when the motors (57A, 57B, 67, 77, 87) which are the stepping motors are rotated. In addition, in the control command, in a case where the control target is the notification portion 99, the command of generating a single sound and a command of generating a continuous sound, are included

Next, a configuration example of the unit type multifunctional electronic device according to the related art will be described.

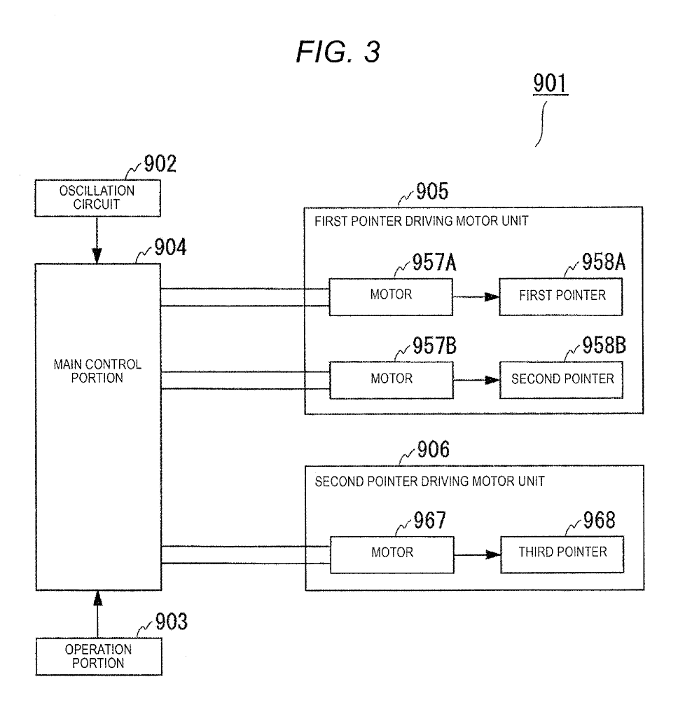

FIG. 3 is a configuration view of a multifunctional electronic device 901 according to the related art. As illustrated in FIG. 3, the multifunctional electronic device 901 according to the related art is provided with an oscillation circuit 902, an operation portion 903, a main control portion 904, a first pointer driving motor unit 905, and a second pointer driving motor unit 906.

The first pointer driving motor unit 905 is provided with a motor 957A, a motor 957B, a first pointer 958A, and a second pointer 958B. The second pointer driving motor unit 906 is provided with a motor 967 and a third pointer 968.

In the multifunctional electronic device 901, the oscillation circuit 902 corresponds to the oscillation circuit 2, and the operation portion 903 corresponds to the operation portion 3. In addition, the first pointer 958A corresponds to the first pointer 58A, the second pointer 958B corresponds to the second pointer 58B, the third pointer 968 corresponds to the third pointer 68.

For example, when displaying the time, the main control portion 904 generates the driving signals of each of the motor 957A, the motor 957B, and the motor 967, and outputs each generated driving signal to the corresponding motor 957A, the motor 957B, and the motor 967.

The motor 957A, the motor 957B, and the motor 967 are stepping motors, and drives the corresponding first pointer 958A, the second pointer 958B, the third pointer 968 by the driving signal output by the main control portion 904.

As illustrated in FIG. 3, in the multifunctional electronic device 901 in the related art, each unit has only the motor and the pointer, and does not include the control portion. Therefore, it is necessary that the main control portion 904 performs the driving by generating the driving signal of each motor (957A, 957B, 967). It is necessary that a creator of a control program of the main control portion 904 creates the driving signal. However, in the stepping motor control, it is necessary to understand the characteristics of the stepping motor loaded on the unit, and to understand the driving method (normal rotation, reverse rotation, stop, or desynchronization prevention) of the stepping motor. Therefore, for example, in a case of configuring a smart watch (multifunctional electronic device) by using the first pointer driving motor unit 905 and the second pointer driving motor unit 906, the burden of the creator of the control program of the main control portion 904 is large. Furthermore, as illustrated in FIG. 3, since it is necessary that the main control portion 904 drives the first pointer driving motor unit 905 and the second pointer driving motor unit 906, the load of the main control portion 904 is large. In addition, if the multifunctional electronic device 901 includes the communication portion (not illustrated), and communicates with a smartphone (multifunctional portable telephone) (not illustrated), compared to processing of the general multifunctional electronic device, the number of processing of the main control portion 904 increases. Therefore, in the multifunctional electronic device 901 of the related art, for example, when the number of units increases and the number of processing of driving the unit increases, a failure is generated in the communication of the smartphone, and when the communication of the smartphone increases, the control of the unit is not possible in some cases.

Meanwhile, in the embodiment, by outputting not the driving signal but the command only to the first pointer driving motor unit 5, the main control portion 4 can also control the other units. As a result, since the creator of the control program of the main control portion 4 may create the control program which sends the command embedded in the information indicating the unit to be operated to the first pointer driving motor unit, the burden of the creator is reduced. Furthermore, even though there are plural units, since the main control portion 4 exchanges the information only with the first pointer driving motor unit 5, the load of the main control portion 4 is reduced. Furthermore, according to the embodiment, it is not necessary that the control program creator of the main control portion 4 understands the characteristics of the stepping motor or the generating method of the driving signal, the command, such as the command of the target time or a mode change command of a countdown timer mode, may be employed, and thus, it is possible to substantially reduce the load of the control program creator in creating the program.

Next, an example in which the main control portion 4, the first pointer driving motor unit 5, the second pointer driving motor unit 6, the third pointer driving motor unit 7, and the fourth pointer driving motor unit 8 are disposed on a substrate 11 will be described.

FIG. 4 is a view illustrating an example in which the main control portion 4, the first pointer driving motor unit 5, the second pointer driving motor unit 6, the third pointer driving motor unit 7, and the fourth pointer driving motor unit 8 are disposed on the substrate 11 according to the embodiment. In addition, in FIG. 4, in each unit, each pointer or the like is omitted. In addition, the example illustrated in FIG. 4 is an example in which the multifunctional electronic device 1 is provided with four units (the first pointer driving motor unit 5, the second pointer driving motor unit 6, the third pointer driving motor unit 7, and the fourth pointer driving motor unit 8). In addition, in FIG. 4, the oscillation circuit 2, the operation portion 3, and the communication portion 10 are omitted.

In addition, in the embodiment, each of a position A to a position D clockwise around a line AB is called a position of twelve o'clock, a position of three o'clock, a position of six o'clock, and a position of nine o'clock.

As illustrated in FIG. 4, on the substrate 11 of the multifunctional electronic device 1, the first pointer driving motor unit 5 is disposed substantially at the center, the main control portion 4 is disposed substantially at the position of nine o'clock, the second pointer driving motor unit 6 is disposed substantially at the position of twelve o'clock, the fourth pointer driving motor unit 8 is disposed substantially at three o'clock, and the third pointer driving motor unit 7 is disposed substantially at position of six o'clock.

In addition, in the first pointer driving motor unit 5, the input portion 52 and the first output portion 53-1 to the third output portion 53-3 are formed on the support body 51, and the first motor 57A and the second motor 57B are attached onto the support body 51. In addition, in the embodiment, the substrate is at least one side among a front side and a rear side of the substrate. For example, the input portion 52 may be formed on the rear side of the support body 51, or may be formed on the front side. The input portion 52 is a connection portion connected with the main control portion 4. In addition, the first output portion 53-1 is a connection portion connected with the second pointer driving motor unit 6, the second output portion 53-2 is a connection portion connected with the third pointer driving motor unit 7, and the third output portion 53-3 is a connection portion connected with the fourth pointer driving motor unit 8.

Next, the connection between the main control portion 4 and the first pointer driving motor unit 5 and the connection between the first pointer driving motor unit 5 and the other unit, will be described.

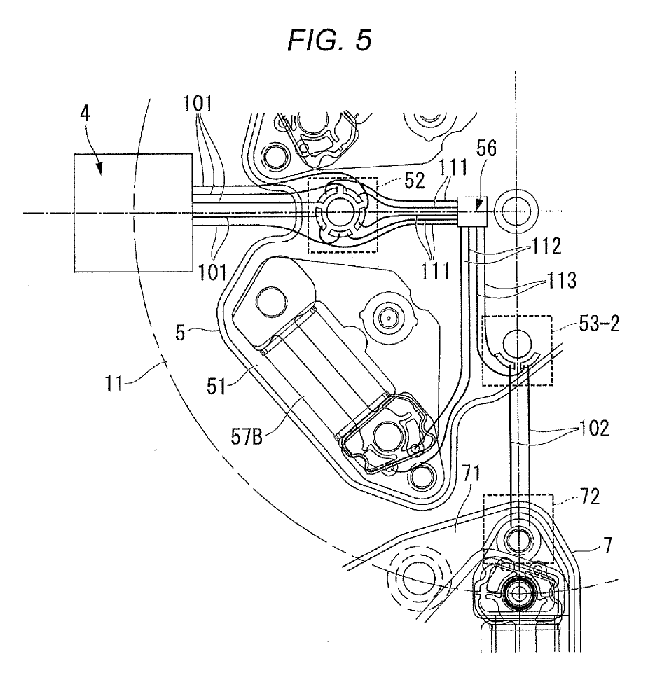

FIG. 5 is a view illustrating the connection between the main control portion 4 and the first pointer driving motor unit 5 and the connection between the first pointer driving motor unit 5 and the second pointer driving motor unit 6 according to the embodiment.

As illustrated in FIG. 5, the main control portion 4 is connected to the input portion 52 of the first pointer driving motor unit 5 by auxiliary connection portions 101 which are five (SS, SCLK, MOSI, MISO, BUSY) wiring patterns, on the substrate 11. Furthermore, the input portion 52 is connected to the control portion 56 by connection portions 111 which are five wiring patterns, on the support body 51. The control portion 56 is connected to the second motor 57B by connection portions 112 which are two wiring patterns, and is connected to the third output portion 53-3 by connection portions 113 which are two wiring patterns on the support body 51.

In addition, the third output portion 53-3 is connected to the input portion 72 of the second pointer driving motor unit 6 by main connection portions 102 which are two wiring patterns on the substrate 11.

In addition, a view illustrating a connection relationship illustrated in FIG. 5 illustrates FIG. 4 taking out a part thereof. In the specific connection relationship in FIG. 4, the main control portion 4 and the input portion 52 of the first pointer driving motor unit 5 are connected to each other by five main connection portions on the substrate 11. The input portion 52 and the control portion 56 are connected to each other by five connection portions on the support body 51. In the control portion 56, the first motor 57A is connected by two connection portions on the support body 51, and the second motor 57B is connected by two connection portions on the support body 51. Furthermore, in the control portion 56, the first output portion 53-1 is connected by the two connection portions on the support body 51, the second output portion 53-2 is connected by two connection portions on the support body 51, and the third output portion 53-3 is connected by the two connection portions on the support body 51. In addition, the first output portion 53-1 and the input portion 72 of the second pointer driving motor unit 6 are connected to each other by two main connection portions on the substrate 11. The second output portion 53-2 and the input portion 82 of the third pointer driving motor unit 7 are connected to each other by the two main connection portions on the substrate 11. The third output portion 53-3 and the input portion 82 of the fourth pointer driving motor unit 8 are connected to each other by the two main connection portions on the substrate 11.

Next, an example of the communication signal between the main control portion 4 and the control portion 56, and an example of the driving signal output by the control portion 56 to each motor, will be described.

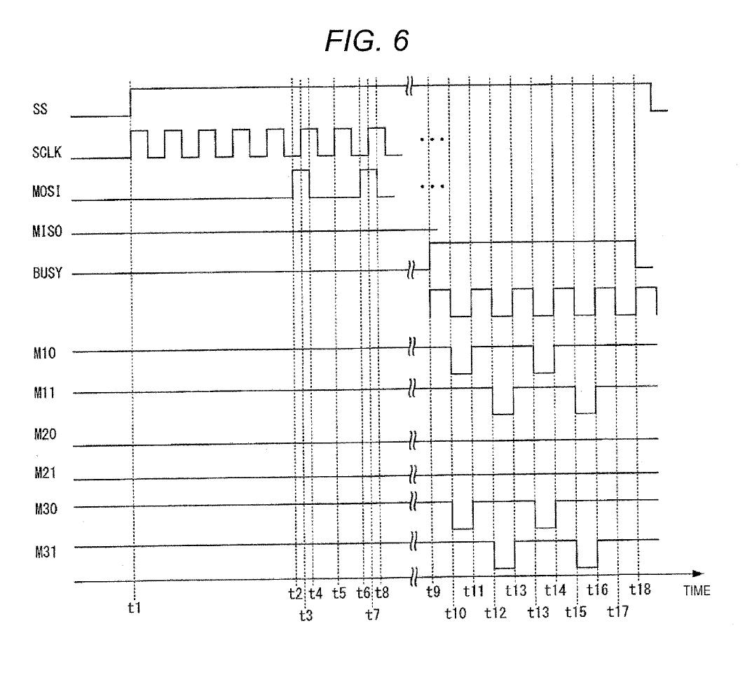

FIG. 6 is a view illustrating an example of the communication signal between the main control portion 4 and the control portion 56, and an example of the driving signal output by the control portion 56 to each motor, according to the embodiment. In FIG. 6, a horizontal axis indicates the time, and a longitudinal axis indicates a high (H) level and a low (L) level of each signal. In FIG. 6, the SS, the SCLK, the MOSI, the MISO, and the BUSY are control signals of the main control portion 4 and the control portion 56. In addition, M10 and M11 are driving signals of the first motor 57A, M20 and M21 are driving signals of the second motor 57B, and M30 and M31 are driving signals of the third motor 67.

The SS is a chip select signal. When the main control portion 4 and the control portion 56 communicates with each other, the main control portion 4 changes the SS from the L level to the H level.

The SCLK is a system clock. The main control portion 4 outputs the SCLK to the control portion 56.

The MOSI is a command output by the main control portion 4.

The MISO is information output by the control portion 56.

The BUSY is a signal output by the control portion 56 to the main control portion 4 in the middle of executing the command.

As illustrated in FIG. 6, the main control portion 4 changes the SS from the L level to the H level at the time t1, and the command in the example illustrated in FIG. 6 is a command of driving the first motor 57A and the third motor 67. Therefore, the control portion 56 outputs the MOSI during the period of time t2 to t3 as a command of driving the first motor 57A and during the period of time t6 to t8 as a command of driving the third motor 67.

In addition, the time t3, t5, and t7 are an example of timing at which the control portion 56 takes the command. In addition, in FIG. 6, the command is 8 bit.

After obtaining the command of 8 bit, the control portion 56 changes the BUSY from the L level to the H level at the time t9, and executes the command by using the information stored by the storage portion 55.

The control portion 56 outputs the M10 as a first driving signal of the first motor 57A and the M31 as a first driving signal of the third motor 67 during the period of time t10 to t11 and during the period of time t14 to t15. In addition, the control portion 56 outputs M11 as a second driving signal of the first motor 57A and M32 as a second driving signal of the third motor 67 during the period of time t12 to t13 and during the period of t16 to t17. In addition, the control portion 56 outputs the driving signal to each motor at the timing of raising the reference signal (for example, 1 Hz) generated by the oscillation circuit 54.

After executing the command, the control portion 56 changes the BUSY from the H level to the L level at the time t18.

Next, an example of a processing order of the multifunctional electronic device 1, will be described.

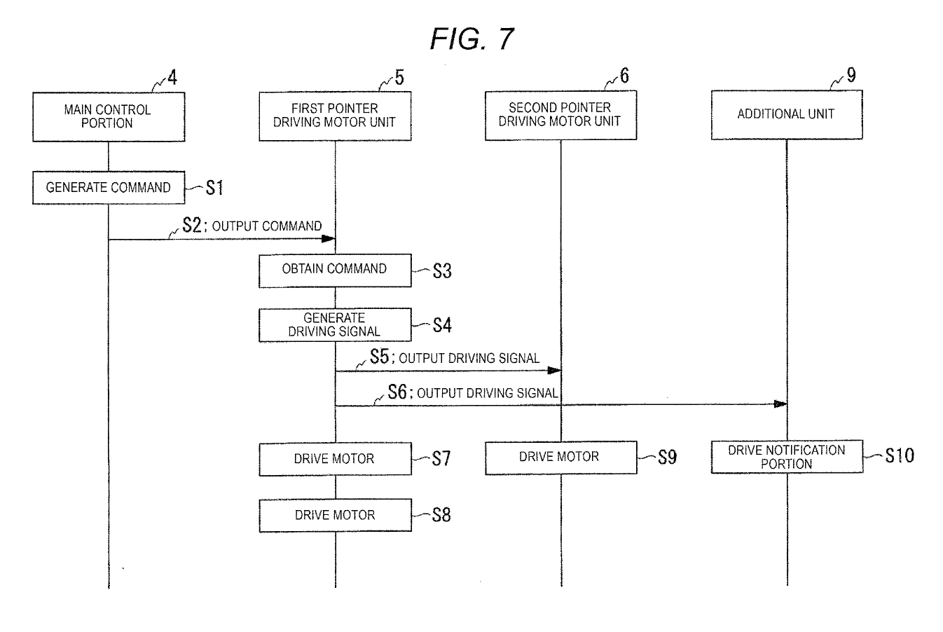

FIG. 7 is a sequence view of the processing of the multifunctional electronic device 1 according to the embodiment. In addition, in the example illustrated in FIG. 7, the multifunctional electronic device 1 is an example in which three units (the first pointer driving motor unit 5, the second pointer driving motor unit 6, and the fifth pointer driving motor unit 9) are provided. In addition, the first pointer driving motor unit 5 is provided with two motors (57A, 57B), the second pointer driving motor unit 6 is provided with the third motor 67, and the additional unit is provided with the notification portion 99. In addition, the second pointer driving motor unit 6 is connected to the first output portion 53-1 via the main connection portion (wiring pattern) on the substrate 11. The additional unit 9 is connected to the second output portion 53-2 via the main connection portion (wiring pattern) on the substrate 11.

(Step S1) The main control portion 4 generates the command of driving the first motor 57A and the second motor 57B of the first pointer driving motor unit 5, the third motor 67 of the second pointer driving motor unit 6, and the notification portion 99 of the additional unit 9.

(Step S2) The main control portion 4 outputs the generated command to the control portion 56 via the auxiliary connection portion 101, the input portion 52, and the connection portion 111.

(Step S3) The control portion 56 obtains the command output by the main control portion 4.

(Step S4) The control portion 56 generates the driving signal to the first motor 57A, the second motor 57B, the third motor 67, and the notification portion 99 by using the obtained command and the information stored by the storage portion 55.

(Step S5) The control portion 56 outputs the generated driving signal to the second pointer driving motor unit 6 via the connection portion on the support body 51, the first output portion 53-1, the main connection portion on the substrate 11, and the input portion 62.

(Step S6) The control portion 56 outputs the generated driving signal to the additional unit 9 via the connection portion on the support body 51, the second output portion 53-2, the main connection portion on the substrate 11, and the input portion 92.

(Step S7) The control portion 56 drives the first motor 57A in accordance with the command generated in step S4.

(Step S8) The control portion 56 drives the second motor 57B in accordance with the command generated in step S4.

(Step S9) The control portion 56 drives the third motor 67 in accordance with the command generated in step S4.

(Step S10) The control portion 56 drives the notification portion 99 in accordance with the command generated in step S4.

In addition, in the practical processing, as described using FIG. 6, the control portion 56 detects the unit included in the command obtained in step S3, and generates the driving signal to the detected unit in step S4.

In addition, in the above-described example, an example in which the main control portion 4 performs the control so as to indicate the time, is illustrated, but the invention is not limited thereto.

Here, an example of processing in a case where the main control portion 4 receives the command from the terminal 20 via a communication portion 10 and a network (not illustrated), is described. In addition, the multifunctional electronic device 1 is provided with the first pointer driving motor unit 5, the second pointer driving motor unit 6, and the third pointer driving motor unit 7.

The terminal 20 sends the information indicating that the mail is received, to the multifunctional electronic device 1 via the network.

Then, the main control portion 4 receives the information indicating that the mail sent by the terminal 20 is received via the BLE communication or the network from the terminal 20 and the communication portion 10.

Then, the main control portion 4 generates the command of driving the fourth pointer 78 of the third pointer driving motor unit 7 at a position indicating that the mail is received in accordance with the information indicating that the mail is received, and outputs the generated command to the control portion 56.

Then, the control portion 56 obtains the command output by the main control portion 4.

Then, the control portion 56 generates the driving signal which drives the fourth motor 77 by using the obtained command and the information stored by the storage portion 55. In addition, the storage portion 55 stores the driving signal of the fourth motor 77 in accordance with the command of driving the fourth pointer 78 at the position indicating that the mail is received.

Then, the control portion 56 drives the fourth motor 77 by outputting the generated driving signal to the third pointer driving motor unit 7. Accordingly, the fourth pointer 78 is driven at the position indicating that the mail is received.

In addition, regarding the fourth pointer 78 which is driven at the position indicating that the mail is received, for example, after the user confirms the mail received by the terminal 20, the terminal 20 sends the command of returning the fourth pointer 78 to an initial position to the multifunctional electronic device 1. The multifunctional electronic device 1 returns the fourth pointer 78 to the initial position in accordance with the command of returning the fourth pointer 78 to the initial position output by the terminal 20.

In addition, in the above-described example, an example in which the first pointer driving motor unit 5 and the second pointer driving motor unit 6 indicate the time by the control of the main control portion 4, is described, but the invention is not limited thereto. For example, the main control portion 4 may obtain the current time from the terminal 20, and may output the command of changing the displayed time to the control portion 56 based on the obtained information. Accordingly, it is possible to correct the display of the time of the multifunctional electronic device 1. In addition, accordingly, even in a case where the user of the multifunctional electronic device 1 moves to a certain country or a region having a time difference, as the user selects a command of matching the time with the local time from the terminal 20, it is possible to match the time display of the multifunctional electronic device 1 with the local time.

In addition, in a case where the multifunctional electronic device 1 is provided with a unit other than a unit which displays the time, the main control portion 4 may output the command of driving the pointer of the unit other than the unit which displays the time to the initial position to the control portion 56, and may control each unit in accordance with the use.

In addition, in the embodiment, an example in which one unit is one or two motors, or one notification portion is provided, is illustrated, but the invention is not limited thereto. The unit may be provided with at least one motor and the notification portion. For example, the unit may be provided with three motors and three pointers, may be provided with one motor and one notification portion, or may be provided with two notification portions.

As described above, the pointer driving motor unit (first pointer driving motor unit 5) of the embodiment is provided with the support body 51, the pointer (the first pointer 58A or the second pointer 58B) which is rotatably supported by the support body, a stepping motor (the first motor 57A or the second motor 57B) which rotates the pointer, the input portion 52 into which the input signal is put from the main control portion 4 connected to the support body from the outside of the support body, and the control portion 56 which is disposed in the support body, and controls the driving of the stepping motor in accordance with the input signal.

According to this configuration, the pointer driving motor unit (first pointer driving motor unit 5) of the embodiment can drive the first motor 57A or the second motor 57B of the unit itself in accordance with the signal (command) output by the main control portion 4. As a result, according to the embodiment, it is possible to satisfy the reduction of the size of the unit, and the ensuring of the controllability in a case where a plurality of the units are incorporated, at the same time.

In addition, in the pointer driving motor unit (first pointer driving motor unit 5) of the embodiment, the support body 51 is provided with the output portion 53 which outputs the output signal that controls other units (for example, the second pointer driving motor unit 6, the third pointer driving motor unit 7, the fourth pointer driving motor unit 8, and the additional unit 9) which are connected to the outside of the support body, and the control portion 56 generates the output signal which controls the other units in accordance with the information included in the input signal.

According to this configuration, the first pointer driving motor unit 5 of the embodiment can drive the load (the motor or the notification portion) of the module (for example, the second pointer driving motor unit 6 to the additional unit 9) connected to the first pointer driving motor unit 5, in accordance with the signal (command) output by the main control portion 4. As a result, according to the embodiment, it is possible to satisfy the reduction of the size of the unit, and the ensuring of the controllability in a case where a plurality of the units are incorporated, at the same time.

In addition, the pointer driving motor unit (first pointer driving motor unit 5) of the embodiment is disposed in the support body 51, is provided with the oscillation circuit 54 which outputs the reference signal, and the control portion 56 controls the driving of at least one of the stepping motor (the first motor 57A or the second motor 57B) and the stepping motor (the third motor 67, the fourth motor 77, and the fifth motor 87) that drives the pointer (for example, the third pointer 68, the fourth pointer 78, and the fifth pointer 88) supported by the other units (for example, the second pointer driving motor unit 6, the third pointer driving motor unit 7, the fourth pointer driving motor unit 8, and the additional unit 9) in synchronization with the reference signal output by the oscillation circuit based on the information included in the input signal.

According to this configuration, for example, even in a case where one unit is provided with the plurality of motors, the multifunctional electronic device 1 of the embodiment can drive each pointer via the motors by outputting the command of driving each motor to the unit. Furthermore, according to the embodiment, in a case where the multifunctional electronic device 1 is provided with the plurality of units, the main control portion 4 does not generate and output the driving signal to each unit, and can integrally output the commands with respect to all of the units provided in the multifunctional electronic device 1 to the unit provided with the control portion 56. As a result, according to the embodiment, it is not necessary that the creator of the control program of the main control portion 4 investigates the characteristics or the control method of the motors of each unit in each individual unit, and it is possible to generate the control program by using the command of driving the motor, and thus, it is possible to reduce the generated load of the control program for operating individual unit. In addition, according to the embodiment, since the main control portion 4 only outputs the command as the control to the control portion 56, it is possible to substantially reduce the load of the processing of the main control portion 4. Accordingly, in the multifunctional electronic device 1, even while the terminal 20 and the main control portion 4 communicate with each other via the communication portion 10, the control portion 56 can drive each unit in accordance with the command.

In addition, in the pointer driving motor unit (first pointer driving motor unit 5) of the embodiment, in a case where the input signal is not input to the input portion 52 for a predetermined time period or longer, based on the reference signal, the control portion 56 controls the driving of the stepping motor (the first motor 57A or the second motor 57B).

According to this configuration, according to the embodiment, in a case where the command is not output from the main control portion 4 for a predetermined time period, by using a reference clock generated by the oscillation circuit 54, for example, by driving the first motor 57A and the second motor 57B of the first pointer driving motor unit 5, the control portion 56 can continuously operate the multifunctional electronic device 1 without stopping the time display function.

In addition, in the pointer driving motor unit (first pointer driving motor unit 5) of the embodiment, in accordance with the information included in the input signal, the control portion 56 outputs the signal (BUSY) indicating that the control is performed via the input portion 52 to the control portion 4 while controlling the driving of at least one of the stepping motor (the first motor 57A or the second motor 57B) and the stepping motor (the third motor 67, the fourth motor 77, and the fifth motor 87) which drives the pointers (for example, the third pointer 68, the fourth pointer 78, and the fifth pointer 88) that is supported by the other units (for example, the second pointer driving motor unit 6, the third pointer driving motor unit 7, the fourth pointer driving motor unit 8, and the additional unit 9).

According to this configuration, according to the embodiment, since the control portion 56 can obtain the BUSY signal via the input portion 52, the main control portion 4 can confirm that the control portion 56 is in the middle of processing. For example, when the BUSY signal indicates that the command is in the middle of being executed, the main control portion 4 can prevent the other commands from being sent. In addition, after sending the command, when a state where the BUSY signal indicates that the command is in the middle of being executed is not achieved even after a predetermined time period has elapsed, the main control portion 4 can send the command again.

In addition, in the above-described example, an example in which the second pointer driving motor unit 6 to the fourth pointer driving motor unit 8 which are connected to the first pointer driving motor unit 5 are provided with the motor, is described, but the invention is not limited thereto. For example, the second pointer driving motor unit may be provided with a liquid crystal driving circuit or a liquid crystal panel.

In addition, in the embodiment, an example in which the other units (for example, the second pointer driving motor unit 6 to the additional unit 9) are connected to the first pointer driving motor unit 5, is described, but the invention is not limited thereto. For example, the third pointer driving motor unit 7 may be connected to the second pointer driving motor unit 6. In this case, for example, the second pointer driving motor unit 6 may be provided with the input portion 62 with respect to the unit itself, and the input portion (not illustrated) with respect to the other units, and may further be provided with the output portion (not illustrated) with respect to the other units. Accordingly, a degree of freedom of the disposition on the substrate 11 further increases. As a result, it is possible to further reduce the size of the multifunctional electronic device 1.

The pointer which is driven by the pointer driving motor unit of the invention includes a rotating needle. In addition, the pointer includes a needle which is used in an indication device, such as a magnet disk or a various types of meters, in addition to the use of a clock.

In addition, in the invention, the program for realizing the function of the control portion 56 may be recorded in the recording medium which can be read by the computer, the program recorded in the recording medium may be read by a computer system, the motor in a module itself may be controlled by the executing the program, and the control of other modules may be performed. In addition, “computer system” referred here includes an OS and hardware such as peripheral equipment. In addition, “computer system” includes a WWW system provided with a homepage provided environment (or display environment). In addition, the “recording medium which can be read by the computer” is a portable medium (for example, a flexible disk, a magneto-optical disk, a ROM, or a CD-ROM), or a recording device, such as a hard disk embedded in the computer system. Furthermore, the “recording medium which can be read by the computer” includes a medium which holds the program for a certain period of time similar to a volatile memory (RAM) on the inside of the computer system which becomes a server or a client in a case where the program is sent via the network, such as the Internet, or the communication circuit, such as a telephone circuit.

In addition, the above-described program may be transmitted from the computer system in which the program is accommodated in a storage device or the like, to the other computer system via a transmitting medium, or by a transmission wave in the transmitting medium. Here, the “transmitting medium” which transmits the program is a medium having a function of transmitting the information similar to the network (communication net), such as the Internet, or the communication circuit (communication line), such as a telephone circuit. In addition, the above-described program may be a program for realizing a part of the above-described function. Furthermore, a program which can realize the above-described function by combining the programs which has already been stored in the computer system, that is, a so-called difference file (difference program), may be employed.

Above, the embodiment of the invention is described, but the invention is not limited to the above-described embodiment, and can be changed in various manners without departing from the scope of the invention.

In addition, the use also can be changed in various manners. For example, the smart watch (multifunctional electronic device) mounted by a driver or the like can receive car speed information, rotation speed information, and fuel residual quantity information, from an internal combustion engine and a BLE sending and receiving device loaded on a vehicle which is driven by the motor or the like, and can also send the command for displaying the car speed, the rotation speed, and the fuel residual quantity from a microcomputer (main control portion) of the smart watch to a drive IC (control portion) of the pointer driving motor unit. Accordingly, the pointer of the pointer driving motor unit can display the car speed information or the like. In addition, it is also possible to directly mount the pointer driving motor unit on an onboard clocking type display portion (inside of an instrument panel or the like).

What is claimed is:

1. A pointer driving motor unit comprising:
a support body;
a pointer configured to be rotatably supported by the support body;
a stepping motor configured to rotate the pointer;
an input portion configured to receive an input signal outputted from a main control portion connected to the support body from the outside of the support body; and
a control portion configured to be disposed in the support body, the control portion being configured to control driving of the stepping motor based at least in part on the input signal.

2. The pointer driving motor unit according to claim 1,
wherein the support body includes an output portion which outputs an output signal that controls another unit connected to the support body, and
wherein the control portion generates the output signal which controls the other unit in accordance with information included in the input signal.

3. The pointer driving motor unit according to claim 2, further comprising:
an oscillation circuit configured to be disposed in the support body, the oscillation circuit being configured to output a reference signal,
wherein the control portion controls at least one of the stepping motor and a stepping motor that drives the pointer supported by the other unit, in synchronization with the reference signal output by the oscillation circuit, based at least in part on the information included in the input signal.

4. The pointer driving motor unit according to claim 3,
wherein the control portion controls the stepping motor based at least in part on the reference signal in a case where the input signal is not input to the input portion for a predetermined time period or longer.

5. The pointer driving motor unit according to claim 2,
wherein the control portion outputs a signal which indicates that the control is performed to the main control portion via the input portion while controlling the driving of at least one of the stepping motor and the stepping motor that drives the pointer supported by the other unit, in accordance with the information included in the input signal.

6. The pointer driving motor unit according to claim 1,
wherein the stepping motor includes a first stepping motor and a second stepping motor, and
wherein the pointer includes a minute hand which is driven by the first stepping motor, and an hour hand which is driven by the second stepping motor.

7. The pointer driving motor unit according to claim 2,
wherein the other unit is provided as a plural,
wherein the output portion is provided as plural to be capable of outputting the output signal to each of the other units, and
wherein the control portion generates a plurality of the output signals which control each of the other units respectively, and outputs the output signals to the plurality of output portions respectively.

8. The pointer driving motor unit according to claim 2,
wherein the other units include at least one of a sound generation element, a light emitting element, and a vibration element.

9. A control method of a pointer driving motor unit including a support body, a pointer which is rotatably supported by the support body, a stepping motor which rotates the pointer, an input portion into which an input signal is put from a main control portion connected to the support body from the outside of the support body, an output portion which outputs a signal that controls driving of other units connected to the support body from the outside of the support body, and a control portion which is disposed in the support body, the method comprising:
a procedure of controlling driving of at least one of the stepping motor and a stepping motor that drives the pointer supported by the other units, in accordance with the signal input from the main control portion.
